(19) United States
(12) Patent Application Publication
(10) Pub. No.: US 2024/0145740 A1
(43) Pub. Date: May 2, 2024

(54) HUMIDIFIER COMPRISING PLATE STACK AND PLATE STACK

(71) Applicant: MANN+HUMMEL GmbH, Ludwigsburg (DE)

(72) Inventors: Alexander KORN, Güglingen (DE); Ralph KEMPER, Ludwigsburg (DE); Herbert PIETROWSKI, Pleidelsheim (DE); Matthias MUELLER, Nordheim (DE); Mario RIEGER, Ludwigsburg (DE)

(21) Appl. No.: 18/407,405

(22) Filed: Jan. 8, 2024

Related U.S. Application Data
(63) Continuation of application No. PCT/EP2022/066116, filed on Jun. 14, 2022.

(30) Foreign Application Priority Data
Jul. 30, 2021 (DE) 102021119892.5

(51) Int. Cl. H01M 8/04119; F28D 21/00

(52) U.S. Cl. CPC H01M 8/04149; F28D 21/0015

(57) ABSTRACT

A humidifier has a housing with inlet and outlet for a first fluid and inlet and outlet for a second fluid. A plate stack with channel plates sequentially arranged in a stacking direction is arranged in the housing. The channel plates have flow channels for the first and second fluids, respectively, separated by semipermeable membranes. The plate stack has a first end plate arranged at a first end and a second end plate arranged at a second end, wherein the first and second ends face away from each other in stacking direction. The housing has a receiving device interacting with a counter receiving device at the plate stack for supporting and sealing the plate stack in the housing. The counter receiving device extends in a plane normal to the stacking direction and is arranged at the first or second end plate. A plate stack for the humidifier is provided.

### CROSS-REFERENCE TO RELATED APPLICATIONS

This application is a continuation application of International Application No. PCT/EP2022/066116 filed on Jun. 14, 2022, which claims the benefit of German Application No. 102021119892.5 filed on Jul. 30, 2021, the entire disclosures of which are incorporated herein by reference for all purposes.

### BACKGROUND

The invention concerns a humidifier, in particular for a fuel cell system, with a housing in which a plate stack is arranged and concerns a plate stack for a humidifier, in particular for a fuel cell system, with a plurality of channel plates sequentially following each other in a stacking direction.

DE 10 2013 020 503 A1 discloses a humidifier which is used to enrich flowing air, which is supplied, for example, to a fuel cell for the electrochemical reaction, with a defined moisture contents. The humidifier comprises a stack unit with a plurality of membranes arranged on top of each other, preferably parallel and spaced apart from each other, which are permeable for water but not for air, respectively, wherein air flows with differently high moisture contents are passed along the oppositely positioned membrane sides so that through the membrane a water or water vapor exchange from the air flow with higher moisture contents to the air flow with lower moisture contents is realized. The humidifier comprises in a housing the stack unit with water vapor-permeable membranes which are arranged between frame parts. The housing comprises supports for holding the stack unit, wherein the connection between supports and the frame parts is realized by laterally projecting connecting noses which project into a receiving groove.

### SUMMARY

It is an object of the invention to provide a humidifier, in particular for a fuel cell system, with an improved arrangement of a plate stack.

A further object is providing a plate stack for an improved arrangement of the plate stack in such a humidifier.

The aforementioned object is solved according to an aspect of the invention by a humidifier, in particular for a fuel cell system, with a housing which at least comprises an inlet for a first fluid, in particular an exhaust gas of the fuel cell system, an inlet for a second fluid, in particular a supply air of the fuel cell system, an outlet for the first fluid, and an outlet for the second fluid, wherein in the housing a plate stack with a plurality of channel plates sequentially following each other in a stacking direction is arranged, which comprise flow channels for the first fluid and for the second fluid separated from each other by semipermeable membranes, wherein the housing comprises at least one receiving device which interacts with a counter receiving device arranged at the plate stack for supporting and sealing the plate stack in the housing.

The further object is solved according to a further aspect of the invention by a plate stack for a humidifier, in particular for a fuel cell system, comprising a plurality of channel plates sequentially following each other in a stacking direction, which comprise flow channels for the first fluid and for the second fluid separated from each other by semipermeable membranes, further comprising a counter receiving device which, for an arrangement of the plate stack as intended in a housing of the humidifier, interacts with a receiving device arranged in the housing for supporting and sealing the plate stack in the housing.

Beneficial configurations and advantages of the invention result from the further claims, the description, and the drawing.

According to an aspect of the invention, a humidifier, in particular for a fuel cell system, is proposed, with a housing which at least comprises an inlet for a first fluid, in particular an exhaust gas of the fuel cell system, an inlet for a second fluid, in particular a supply air of the fuel cell system, an outlet for the first fluid, and an outlet for the second fluid, wherein in the housing a plate stack with a plurality of channel plates sequentially following each other in a stacking direction is arranged which comprise flow channels for the first fluid and for the second fluid separated from each other by semipermeable membranes. The plate stack is framed at ends facing away from each other in the stacking direction by an end plate, respectively. The housing comprises at least one receiving device which interacts with a counter receiving device arranged at the plate stack for supporting and sealing the plate stack in the housing. The counter receiving device extends in a plane normal to the stacking direction and is arranged at least at one of the end plates of the plate stack.

The end plates close the plate stack in stacking direction at the ends. In embodiments, at least one device component of the counter receiving device is formed as one piece together with the end plate, in particular is monolithically injection-molded with a plastic material of the end plate.

The humidifier represents a special embodiment of a flat membrane humidifier. A first moist or water-rich fluid, for example, exhaust gas of fuel cells, flows in one group of flow channels while a second dry fluid, for example, supply air for the fuel cells, flows in another group of flow channels. Through the semipermeable membranes, the second dry fluid can be humidified by the first fluid.

The plate stack with the channel plates is floatingly sealed in the housing, for example, axially by two axially acting seals located at the ends at inlet side and outlet side of the first or second fluid. These seals can seal either the supply air region or the exhaust air region. Preferably, the supply air region is sealed in this context.

In embodiments, a counter receiving device can be arranged at both end plates, respectively.

In embodiments, the flow channels define flow directions for the first fluid and for the second fluid, respectively, wherein the flow directions extend at an angle to each other, in particular perpendicularly to each other. In this context, the counter receiving device can extend, at least in sections, parallel to one of the flow directions.

Alternatively, the counter receiving device can extend, at least in sections, at an acute angle to at least one of the flow directions for the first fluid and/or the second fluid.

In embodiments, the counter receiving device forms a V shape at the respective end plate. This has the advantage that, in addition to the holding forces acting in the direction of gravity, holding forces in directions perpendicular to the direction of gravity can be absorbed. In other words, the holding action transverse to the direction of gravity is improved in this way.

In embodiments, the channel plates and end plates each can have a polygonal shape, in particular a rectangular shape, wherein the counter receiving device extends between two oppositely positioned edges of at least one of the end plates of the plate stack.

In embodiments, the counter receiving device does not extend in corner areas of the polygonal end plates.

In particular, the counter receiving device extends between two oppositely positioned edges of the polygonal end plate. In particular, the counter receiving device extends from a region of an edge positioned between two immediately neighboring corners into a region positioned between two immediately neighboring corners of an oppositely positioned edge, in particular centrally, respectively, in relation to the respective immediately neighboring corners.

The plate stack is supported by means of two support ribs which are arranged laterally at the plate stack, extend in sealing direction of the axial seal, and act as counter receiving device and which engage in guide grooves of the housing as receiving device. In addition to the support action, the thus realized tongue-and-groove connection also provides for sealing a bypass flow of the fluid flow which is not directly sealed. Preferably, the contact location of the tongue-and-groove connection is realized by an elastomer element as a seal device, for example, an O-ring or a shaped seal. This assists in the sealing action and serves at the same time as vibration damper in order to minimize vibrations developing in operation on the plate stack.

As an alternative, the support ribs can be arranged at the housing and the guide grooves at the plate stack.

In this manner, no direct fixed contact of the plate stack at the housing of the humidifier occurs. The plate stack is thus floatingly supported. A possibly occurring axial air gap can be sealed by the axial seal or the seal device of the tongue- and -groove support. In this way, the supply air flow can be sealed effectively in relation to the exhaust gas flow. At the same time, the seals enable a beneficial vibration damping of the plate stack in case of possibly developing vibrations in operation.

The channel plates of the plate stack can be embodied, for example, as stainless steel plates but also as plastic plates, for example of PPS (polypropylene sulfide).

The housing of the humidifier can be made of metal, for example, of aluminum. As an alternative, it is also possible that the housing is made of plastic material, for example of PPS, PPA (polyphthalamide), PA (polyamide).

The housing can be of a multi-part configuration with a removable cover. In this manner, the plate stack can be removed from the housing and/or exchanged for service purposes.

Beneficially, the semipermeable membrane can be formed of a microporous material. The micropores in the material enable a moisture transport through the membrane. Advantageously, the moisture transport can be realized by means of capillary action in the microporous material. In particular, the membrane can be formed of PFSA. PFSA is a plastic material of perfluorosulfonic acid and is known inter alia by the trade name NAFION. The membrane can comprise at both sides porous layers, in particular nonwoven layers, for protection and for mechanical stabilization.

According to a beneficial embodiment of the humidifier, the receiving device or the counter receiving device can comprise, transverse, in particular perpendicular, to a gravitational force direction, at least two oppositely positioned guide grooves. Furthermore, the counter receiving device or the receiving device can comprise at least two oppositely positioned support ribs. In this context, the guide grooves and the support ribs can engage each other for an arrangement of the plate stack in the housing as intended. By means of this tongue-and-groove connection, in particular in combination with a seal device, the plate stack can be advantageously floatingly supported and, at the same time, sealed in relation to a bypass flow of the first fluid. The tongue-and-groove connection assists in the sealing action and serves at the same time as vibration damper in order to minimize the vibrations developing in operation on the plate stack.

According to a beneficial embodiment of the humidifier, the receiving device or the counter receiving device can comprise seal devices, whereby, in case of an arrangement of the plate stack in the housing as intended, an axial sealing of the plate stack in relation to the housing can be affected. The seal device effects thus advantageously a sealing action, for example, in a vertical axis of the housing in relation to a flow around the plate stack from a first interior of the housing into a second interior of the housing, for example, a flow from a top interior of the housing to a bottom interior. In particular, a bypass flow of the first fluid or of the second fluid around the plate stack can be prevented by means of the seal devices. At the same time, the seal devices serve as vibration dampers in order to minimize vibrations developing in operation on the plate stack.

The seal device can be realized, for example, as an EPDM (ethylene propylene diene rubber) element. As an alternative, it is also possible to connect the seal device by foaming, for example, with a material based on silicone. The seal can be produced as a so-called CIP (cured in place) seal.

According to a beneficial embodiment of the humidifier, the seal devices can be arranged at oppositely positioned sides of the support ribs or of the guide ribs. In this way, a two-sided and thus twofold sealing action is advantageously provided. In addition, the seal device can thus act even better as vibration damper for the plate stack.

According to a beneficial embodiment of the humidifier, the seal devices can be arranged circumferentially at the oppositely positioned sides of the support ribs or the guide ribs. In this way, a two-sided and thus twofold sealing action is advantageously provided. The seal device can act additionally even better as vibration damper for the plate stack. Also, additionally beneficial O-ring seals can be employed in this way, for example.

According to a beneficial embodiment of the humidifier, the support ribs can comprise axial seal sections at the two oppositely positioned end faces. In this way, the axial sealing action is further reinforced. Also, by means of such an arrangement of the axial seal sections, the vibration damping in the region of the support ribs can be reinforced.

According to a beneficial embodiment of the humidifier, the axial seal sections can be formed as one piece together with the seal devices. In this manner, the axial seal sections can be produced inexpensively and can be arranged captively. Mounting of the plate stack is thus facilitated.

According to a beneficial embodiment of the humidifier, the plate stack can be sealed with a circumferentially extending axial seal at two oppositely positioned end faces, in particular at an inflow region and outflow region of the first or second fluid. In this context, the circumferentially extending seal can be arranged in a groove at the plate stack and seal against an inner side of the housing. Alternatively, the circumferentially extending seal can be arranged in a groove at an inner side of the housing and seal against the plate stack. By means of the axial seal, the second fluid flow, namely the supply air for the fuel cells, can be sealed in an effective manner in relation to the first fluid flow, namely the exhaust gas of the fuel cells. The humidifier can perform an efficient humidification of the supply air by humidification through the semipermeable membranes. No mixing of supply air and exhaust air takes place.

According to a further aspect of the invention, a plate stack for a humidifier, in particular for a fuel cell system, is proposed, comprising a plurality of channel plates sequentially following each other in a stacking direction, which comprise flow channels for the first fluid and for the second fluid separated from each other by semipermeable membranes. The plate stack is framed at the ends facing away from each other in the stacking direction by an end plate, respectively. Furthermore, the plate stack comprises a counter receiving device which, for an arrangement of the plate stack as intended in a housing of the humidifier, interacts with a receiving device arranged in the housing for supporting and sealing the plate stack in the housing. The counter receiving device extends in a plane normal relative to the stacking direction and is arranged at least at one of the end plates of the plate stack.

In embodiments, a counter receiving device can be arranged at both end plates, respectively. Alternatively or in addition, the at least one counter receiving device can be embodied as one piece together with at least one of the end plates.

In embodiments, the flow channels each define flow directions for the first fluid and for the second fluid, wherein the flow directions extend at an angle relative to each other, in particular perpendicularly to each other. In this context, the counter receiving device can extend, at least in sections, parallel to one of the flow directions.

Alternatively, the counter receiving device can extend, at least in sections, at an acute angle in relation to one of the flow directions.

In embodiments, the counter receiving device forms a V shape at the respective end plate. This has the advantage that, in addition to the holding forces acting in the direction of gravity, holding forces in directions perpendicular to the direction of gravity can be absorbed. In other words, the holding action transverse to the direction of gravity is improved.

In embodiments, the channel plates and end plates each can have a polygonal shape, in particular a rectangular shape, wherein the counter receiving device extends between two oppositely positioned edges of at least one of the end plates of the plate stack.

In embodiments, the counter receiving device does not extend in corner areas of the polygonal end plates.

In particular, the counter receiving device extends between two oppositely positioned edges of the polygonal end plate. In particular, the counter receiving device extends from a region of an edge positioned between two immediately neighboring corners into a region positioned between two immediately neighboring corners of an oppositely positioned edge, in particular centrally, respectively, in relation to the respective immediately neighboring corners.

According to a beneficial embodiment of the plate stack, the counter receiving device can comprise seal devices, whereby, in an arrangement of the plate stack as intended in the housing, an axial sealing action of the plate stack in relation to the housing can be affected. In particular, a bypass flow of the first fluid or of the second fluid around the plate stack can be prevented by means of the seal devices. The seal device effects thus advantageously a sealing action in a vertical axis of the housing in relation to flow around the plate stack from a top interior of the housing to a bottom interior. In particular, a bypass flow of the first fluid or of the second fluid about the plate stack can be prevented by means of the seal devices. At the same time, the seal devices act as vibration dampers in order to minimize vibrations developing in operation on the plate stack.

The seal device can be realized, for example, as an EPDM (ethylene propylene diene rubber) element. As an alternative, it is also possible to connect the seal device by foaming, for example, with a material based on silicone. The seal can be produced as a CIP (cured in place) seal.

### BRIEF DESCRIPTION OF DRAWINGS

Further advantages result from the following drawing description. In the drawings, embodiments of the invention are illustrated. The drawings, the description, and the claims contain numerous features in combination. A person of skill in the art will consider the features expediently also individually and combine them to expedient further combinations.

FIG. 1 shows a humidifier, in particular for a fuel cell system, according to an embodiment of the invention in isometric illustration.

FIG. 2 shows a plate stack according to an embodiment of the invention in isometric illustration.

FIG. 3 shows a longitudinal section through the humidifier according to FIG. 1.

FIG. 4 shows an enlarged detail of the longitudinal section of the humidifier according to FIG. 3.

FIG. 5 shows a cross section through the humidifier according to FIG. 1.

FIG. 6 shows a further longitudinal section through the humidifier according to FIG. 1.

FIG. 7 shows an enlarged detail of the longitudinal section of the humidifier according to FIG. 6 with the plate stack.

FIG. 8 shows a plate stack according to a further embodiment of the invention in isometric illustration.

### DETAILED DESCRIPTION

In the Figures, same or same-type components are identified with same reference characters. The Figures show only examples and are not to be understood as limiting.

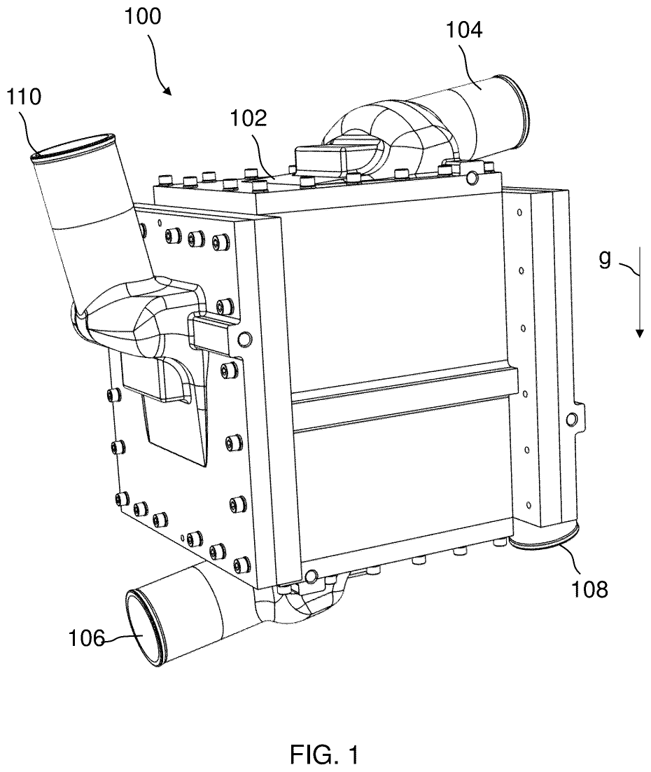

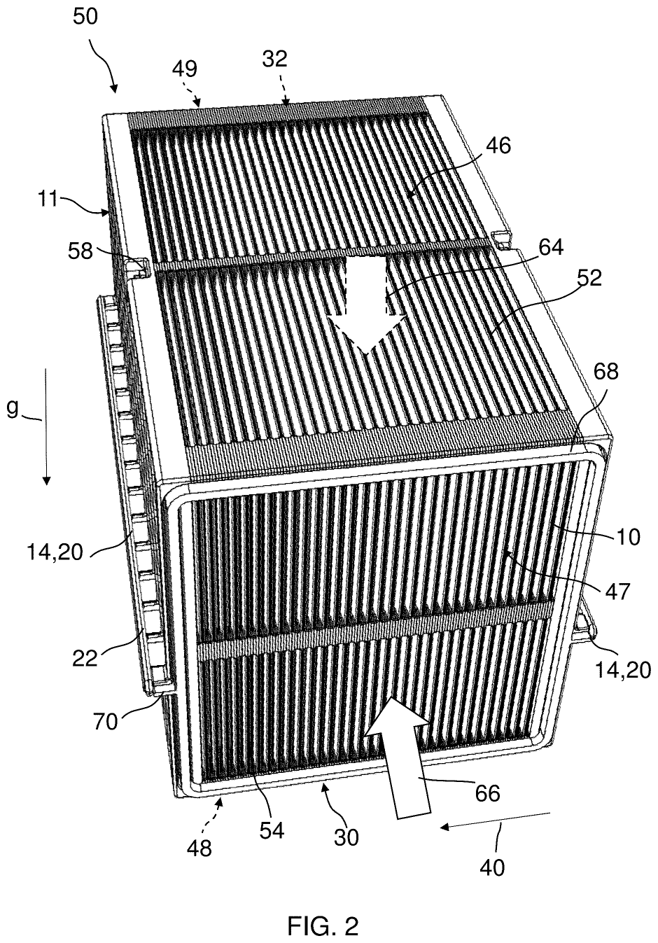

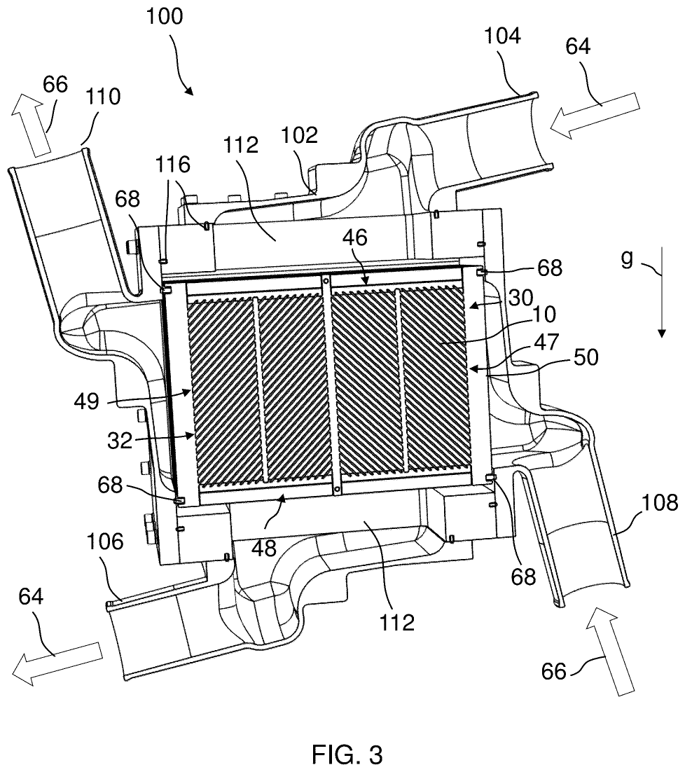

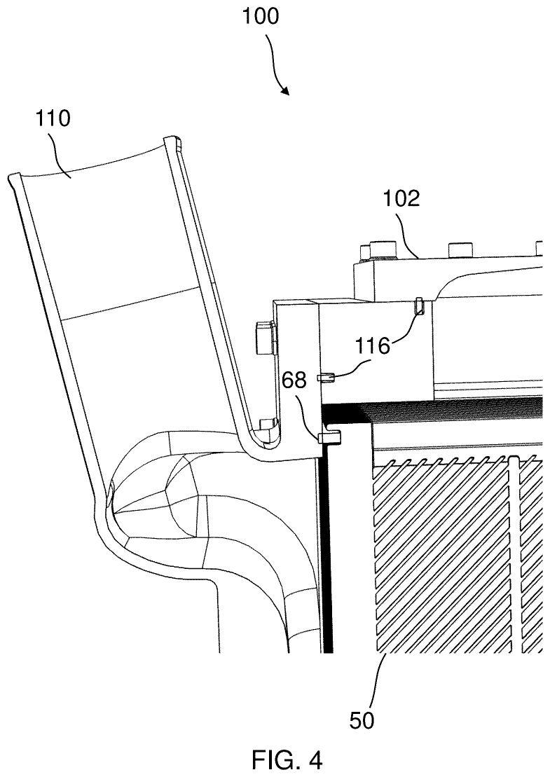

FIG. 1 shows a humidifier 100, in particular for a fuel cell system, according to an embodiment of the invention in isometric illustration from an exterior side. FIG. 2 shows a plate stack 50 according to an embodiment of the invention in isometric illustration. In FIG. 3, a longitudinal section through the humidifier 100 with a plate stack 50 is illustrated while in FIG. 4 an enlarged detail of the longitudinal section of the humidifier according to FIG. 3 is illustrated.

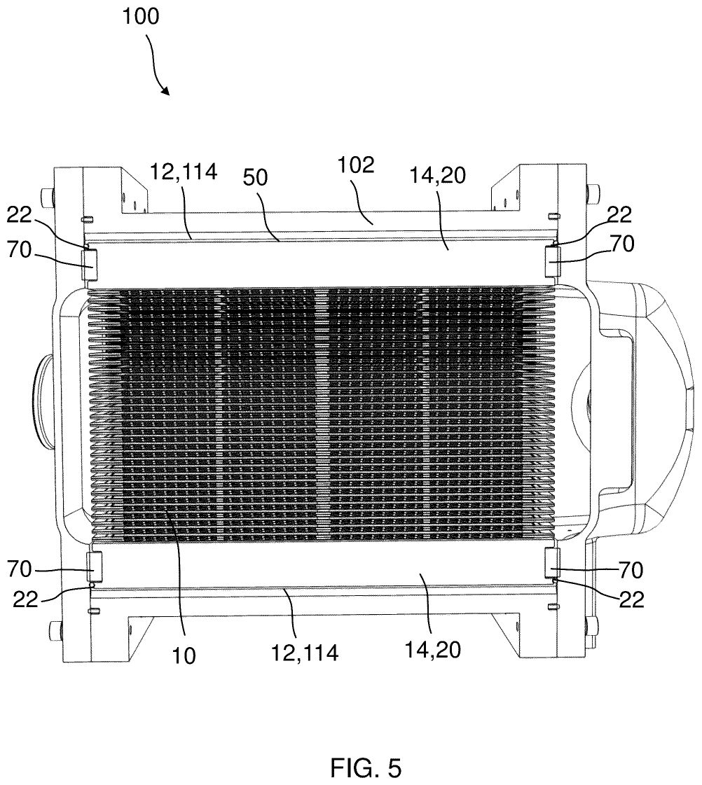

FIG. 5 shows a cross section through the humidifier 100.

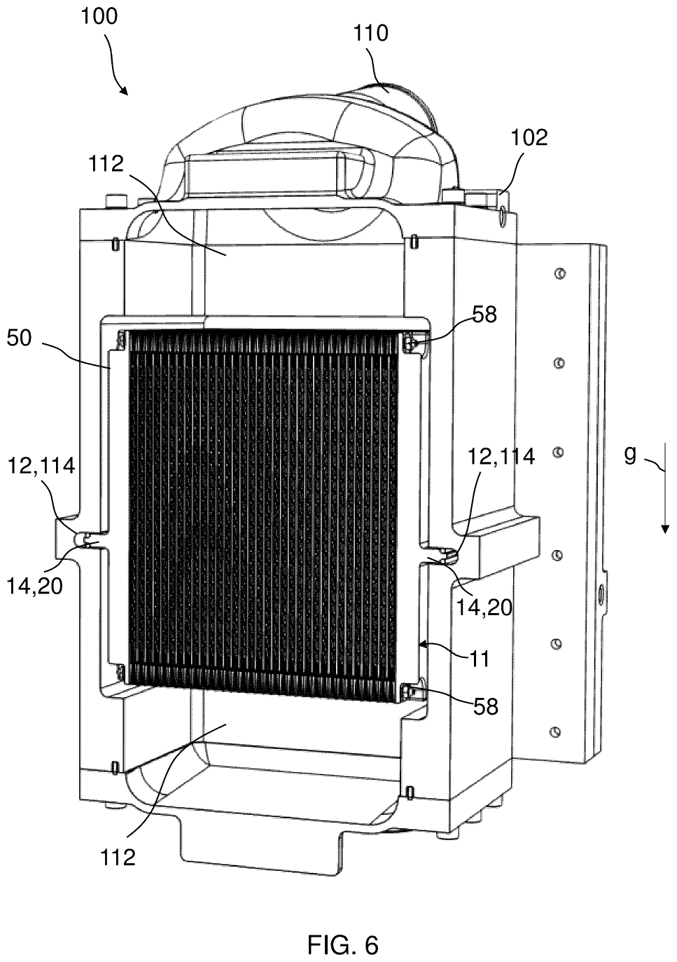

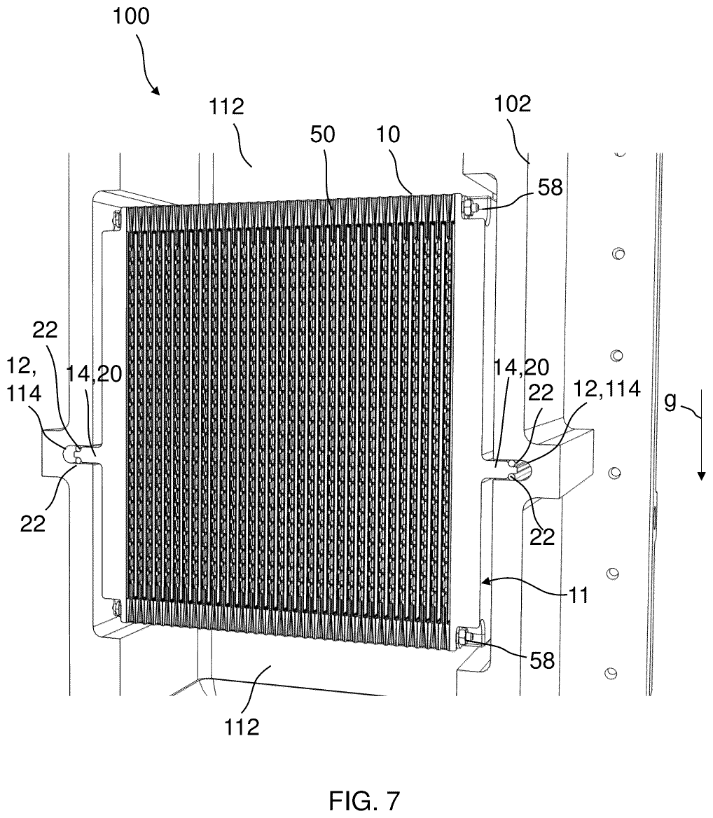

FIG. 6 shows a further longitudinal section through the humidifier rotated by 90° about the vertical axis and FIG. 7 an enlarged detail of the longitudinal section according to FIG. 6.

As can be seen in FIG. 1 and in FIG. 3, the humidifier 100 comprises a housing 102 which comprises an inlet 104 for a first fluid 64, in particular an exhaust gas of the fuel cell system, an inlet 108 for a second fluid 66, in particular a supply air of the fuel cell system, an outlet 106 for the first fluid 64, and an outlet 110 for the second fluid 66. In this context, the exhaust gas is preferably guided as first fluid in direction of gravity g from the top to the bottom so that possibly condensed water does not remain in the plate stack 50 but can be discharged to the outlet 106 as a result of the force of gravity.

A plate stack 50 with a plurality of channel plates 10 sequentially following each other in a stacking direction 40 is arranged in the housing 102, as illustrated in FIG. 2. The channel plates 10 are clamped relative to each other by tie rods 58.

As can be seen in FIG. 2, the channel plates 10 comprise flow channels 52, 54 for the first fluid 64 and for the second fluid 66 separated from each other by semipermeable membranes. In this context, the first fluid 64, namely the exhaust gas, enters the flow channels 52 via the inflow region 46 from above in the illustration and exits again through the outflow region 48, not visible, at the bottom side of the plate stack 50. The second fluid 66, namely the supply air, enters the flow channels 54 from the end face 30 via the inflow region 47 and exits at the oppositely positioned end face 32 via the outflow region 49.

The plate stack 50 is sealed by a circumferentially extending axial seal 68 at the two oppositely positioned end faces 30, 32, in particular at the inflow region 47 and the outflow region 49 of the second fluid 66. In this context, the circumferentially extending axial seal 68 is arranged in a groove, not visible, at the plate stack 50 and seals against an inner side of the housing 102, as can be seen in FIGS. 3 and 4.

As an alternative, the circumferentially extending seal 68 can be arranged in a groove at an inner side of the housing 102 and seal against the plate stack 50.

The plate stack 50 comprises furthermore a counter receiving device 14 which, for an arrangement of the plate stack 50 as intended in the housing 102 of the humidifier 100, interacts with a receiving device 12 arranged in the housing 102 for supporting and sealing the plate stack 50 in the housing 102. The counter receiving device 14 is formed as two support ribs 20 arranged at the sides of the plate stack 50. The counter receiving device 14 comprises furthermore a circumferentially extending seal device 22, here embodied as O-ring. At the end faces 30, 32, the counter receiving device 14 comprises additionally axial seal sections 70 which in this embodiment are formed as one piece together with the axial seal 68. The counter receiving device 14 is arranged at the two end plates 11 of the plate stack 50 which are facing away from each other in stacking direction 40. The counter receiving device 14, or support ribs 20 which form it partially, extends in a plane which is normal to or extends perpendicularly to the stacking direction 40. The counter receiving device 14 or support ribs 20 of the counter receiving device 14 extend with a main extension component parallel to one of the flow directions in the flow channels 52, 54, in particular parallel to the flow direction 66 of the second fluid.

The counter receiving device 14, more precisely the support ribs 20 partially forming it, is in particular embodied as one piece with a material of the end plate 11, in particular injection-molded monolithically from a plastic material. The seal device 22 is either applied to the support ribs 20 as a separate part or injection-molded therewith as one piece by a 2K method.

FIG. 3 shows in longitudinal section the installation position of the plate stack 50 in the housing 102. The exhaust gas 64 enters the interior 112 of the housing 102 via the inlet 104 and flows via the inflow region 46 through the plate stack 50. Via the outflow region 48 at the bottom side of the plate stack 50, the exhaust gas 64 exits again and leaves the housing 102 through outlet 106. The supply air 66 enters the housing 102 via the inlet 108 and flows at the end face 30 via the inflow region 47 into the plate stack 50. Via the outflow region 49 at the end face 32, the humidified supply air 66 exits again from the plate stack 50 and leaves the housing 102 through outlet 110.

The plate stack 50 is sealed at the end faces 30, 32 by the axial seal 68 against the inner side of the housing 102. In the here illustrated embodiment, the supply air region is effectively sealed in relation to the exhaust gas region in this manner.

As a built housing 102, the housing 102 comprises several housing parts which are sealed against each other by housing seals 116. Some of the housing seals 116 are identified in an exemplary fashion. By removing, for example, a housing cover, the plate stack 50 can be removed from the housing 102 and exchanged.

In the cross section of the humidifier 100 illustrated in FIG. 5 and in particular in the longitudinal sections illustrated in FIGS. 6 and 7, the support action of the plate stack 50 in the housing 102 can be seen.

The housing 102 comprises a receiving device 12 which interacts with the counter receiving device 14 arranged at the plate stack 50 for supporting and sealing the plate stack 50 in the housing 102. Transverse, in particular perpendicular, to the gravitational force direction g, the receiving device 12 comprises for this purpose two oppositely positioned guide grooves 114 while, as illustrated already in FIG. 2, the counter receiving device 14 comprises two oppositely positioned support ribs 20. The guide grooves 114 and the support ribs 20 engage each other for an arrangement of the plate stack 50 in the housing 102 as intended.

The counter receiving device 14 at the plate stack 50 comprises seal devices 22 in the form of O-rings. In this way, for an arrangement of the plate stack 50 in the housing 102 as intended, an axial sealing of the plate stack 50 against the housing 102 is affected. In particular, a bypass flow of the exhaust gases 64 around the plate stack 50 is prevented by the seal devices 22.

In the here illustrated embodiment, the seal devices 22 are arranged circumferentially at oppositely positioned sides of the support ribs 20. As can be seen in FIG. 2, the support ribs 20 comprise, at two oppositely positioned end faces 30, 32, axial seal sections 70 which are formed as one piece together with the seal devices 22.

In FIG. 5, the plate stack 50 is sectioned in cross section at the level of the counter receiving device 14 so that the support ribs 20 as well as the sectioned O-ring of the seal device 22 can be seen. Furthermore, the axial seal sections 70 which seal against the inner side of the housing 102 are shown in section. The support ribs 20 are positioned in the also sectioned guide grooves 114 as receiving device 12.

In longitudinal section in FIGS. 6 and 7, the support action of the plate stack 50 by means of support ribs 20 which are pushed into the guide grooves 114 can be seen. In this context, the circumferentially extending O-ring of the seal device 22 seals against a top side and a bottom side of the guide groove 114. In this manner, it can be advantageously prevented that a bypass flow of the exhaust gas 64 can flow laterally past the plate stack 50 through the guide groove 114 from the top part of the interior 112 into the bottom part of the interior 112.

In an alternative embodiment, not illustrated, the support ribs 20 can also be arranged at the housing 102 and the guide grooves 114 in the sidewalls of the plate stack 50.

It is also possible as an alternative that the seal device 22, independent of the arrangement of support ribs 20 and guide grooves 114, is arranged in the housing 102.

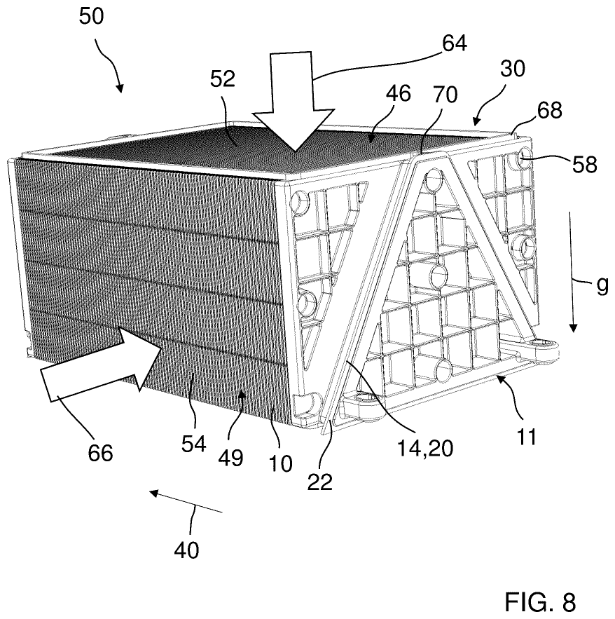

In FIG. 8, an isometric view of a further embodiment of the plate stack 50 according to the invention is illustrated. In regard to the basic construction, the plate stack is identical to the herein described first embodiment so that features, feature combinations as well as their specific technical advantages can be applied to the further embodiment.

The plate stack 50 according to the further embodiment differs from this by the configuration of the counter receiving device 14.

The counter receiving device 14 is arranged at the two end plates 11 of the plate stack 50 which are facing away from each other in stacking direction 40. The counter receiving device 14, or the support ribs 20 partially forming it, extends in a plane which is normal to or extends perpendicularly to the stacking direction 40. The counter receiving device 14 or the support ribs 20 of the counter receiving device 14 extends/extend with a main extension component at an acute angle to the flow directions in the flow channels 52, 54. In particular, the counter receiving device 14 or the support ribs 20 of the counter receiving device 14 extends/extend at an acute angle to the flow direction 64 of the first fluid and to the flow direction 66 of the second fluid.

The counter receiving device 14, or the support ribs 20 partially forming it, forms a V shape at the end plates 11. The V-shaped counter receiving device 14 carries a seal device 22 which, in the region of an in particular flat tip of the V, is connected to the axial seal section 70, in particular is embodied as one piece therewith. The counter receiving device 14, more precisely the support ribs 20 forming it partially, is in particular embodied as one piece with a material of the end plates 11, in particular injection-molded monolithically of a plastic material. The seal device 22 is either applied to the support ribs 20 as a separate part or injection-molded therewith as one piece by a 2K method or produced as a CIP (cured in place) seal.

1. A humidifier comprising:
a housing comprising an inlet for a first fluid, an inlet for a second fluid, an outlet for the first fluid, and an outlet for the second fluid;
a plate stack arranged in the housing and comprising channel plates sequentially following each other in a stacking direction of the plate stack, the channel plates comprising flow channels for the first fluid and for the second fluid, respectively; and
semipermeable membranes separating the flow channels from each other,
wherein the plate stack further comprises:
a first end and a second end that are facing away from each other in the stacking direction;
a first end plate arranged at the first end; and
a second end plate arranged at the second end,
wherein the housing further comprises at least one receiving device, and
wherein the plate stack further comprises a counter receiving device configured to interact with the at least one receiving device of the housing, for supporting and sealing the plate stack in the housing, the counter receiving device being arranged at the first end plate or the second end plate, and the counter receiving device having a V shape.

2. The humidifier according to claim 1, further comprising another counter receiving device configured to interact with the at least one receiving device of the housing, for supporting and sealing the plate stack in the housing, the other counter receiving device being arranged at the second end plate,
wherein the counter receiving device is arranged at the first end plate.

3. The humidifier according to claim 1, wherein the counter receiving device is formed as one piece together with the first end plate or the second end plate.

4. The humidifier according to claim 1, wherein the flow channels define a first flow direction for the first fluid and a second flow direction for the second fluid, the first flow direction and the second flow direction extend at an angle relative to each other.

5. The humidifier according to claim 4, wherein the first flow direction and the second flow direction extend perpendicularly to each other, and
wherein the counter receiving device extends, at least in a section, parallel to one of the first flow direction and the second flow direction.

6. The humidifier according to claim 4, wherein the first and second flow directions extend perpendicularly to each other, and
wherein the counter receiving device extends, at least in a section, at an acute angle relative to one of the first flow direction and the second flow direction.

7. The humidifier according to claim 1, wherein each of the channel plates, the first end plate, and the second end plate has a polygonal shape.

8. The humidifier according to claim 7, wherein the polygonal shape is a rectangular shape, and
wherein the counter receiving device extends between opposite edges of the rectangular shape of the first end plate or the second end plate.

9. The humidifier according to claim 1, wherein the at least one receiving device comprises, transverse to a gravitational force direction in a mounting state of the humidifier, guide grooves oppositely positioned to each other in the stacking direction,
wherein the counter receiving device comprises support ribs oppositely positioned to each other in the stacking direction, and
wherein the guide grooves and the support ribs engage each other when the plate stack is arranged in the housing.

10. The humidifier according to claim 9, wherein the counter receiving device comprises one or more seal devices configured to seal the plate stack against the housing when the plate stack is arranged in the housing.

11. The humidifier according to claim 10, wherein the one or more seal devices is further configured to prevent a bypass flow of the first fluid or the second fluid around the plate stack.

12. The humidifier according to claim 10, wherein two of the one or more seal devices are arranged at opposite sides of the support ribs.

13. The humidifier according to claim 10, wherein the one or more seal devices are arranged circumferentially at opposite sides of the support ribs.

14. The humidifier according to claim 10, wherein the support ribs comprise axial seal sections arranged at opposite end faces of the plate stack.

15. The humidifier according to claim 14, wherein the axial seal sections are formed as one piece together with the one or more seal devices.

16. The humidifier according to claim 14, the one or more seal devices are connected to the axial seal sections, respectively, in a flat tip of the V shape of the counter receiving device.

17. The humidifier according to claim 1, further comprising a circumferentially extending axial seal configured to seal the plate stack is sealed at opposite end faces, the circumferentially extending axial seal being arranged in a groove at the plate stack and being configured to seal against an inner side of the housing.

18. The humidifier according to claim 16, wherein the opposite end faces of the plate stack comprise an inflow region and an outflow region, respectively, of the first fluid or the second fluid.

19. A plate stack for use in a humidifier, the plate stack comprising:
channel plates sequentially following each other in a stacking direction, the channel plates comprising flow channels for a first fluid and for a second fluid;
semipermeable membranes separating the flow channels from one another;
a first end and a second end that are facing away from each other in the stacking direction;
a first end plate arranged at the first end;
a second end plate arranged at the second end; and
a counter receiving device configured to interact with at least one receiving device arranged in a housing of the humidifier, for supporting and sealing the plate stack in the housing, the counter receiving device being arranged at the first end plate or at the second end plate, and the counter receiving device having a V shape.

20. The plate stack according to claim 19, wherein the at least one receiving device comprises, transverse to a gravitational force direction in a mounting state of the humidifier, guide grooves oppositely positioned to each other in the stacking direction,
wherein the counter receiving device comprises support ribs oppositely positioned to each other in the stacking direction,
wherein the guide grooves and the support ribs engage each other when the plate stack is arranged in the housing,
wherein the counter receiving device comprises one or more seal devices configured to seal the plate stack against the housing when the plate stack is arranged in the housing,
wherein the support ribs comprise axial seal sections arranged at opposite end faces of the plate stack, and
wherein the one or more seal devices are connected to the axial seal sections, respectively, in a flat tip of the V shape of the counter receiving device.
